(19) United States
(12) Patent Application Publication
(10) Pub. No.: US 2025/0358218 A1
(43) Pub. Date: Nov. 20, 2025

(54) REDUNDANT USER PLANE PATHS COORDINATION BASED ON MULTIPLE TERMINAL DEVICES PER TERMINAL DEVICE GROUP

(71) Applicant: NOKIA SOLUTIONS AND NETWORKS OY, Espoo (FI)

(72) Inventors: Hua CHAO, Shanghai (CN); Zhu Yan ZHAO, Beijing (CN); Jun SHEN, Hangzhou, Zhejiang (CN); Yonggang WANG, Shanghai (CN); Tao TAO, Shanghai (CN); Ke Jie CHEN, Hangzhou, Zhejiang (CN)

(21) Appl. No.: 18/862,746

(22) PCT Filed: May 12, 2022
(86) PCT No.: PCT/CN2022/092407

§ 371 Date: Nov. 4, 2024

(51) Int. Cl. H04L 45/24; H04L 41/0894; H04W 24/08

(52) U.S. Cl. CPC H04L 45/24; H04L 41/0894; H04W 24/08

(57) ABSTRACT

Embodiments of the present disclosure relate to user plane paths coordination based on multiple UEs per device. A network controller of a network system, the network controller managing a plurality of network devices, receives status information from a network device, wherein the status information comprises measurements provided by a terminal device to the network device and measurements specific to the network device, determines a coordination policy based on the status information, the coordination policy indicating a plurality of redundant user paths to be set by the network device for the terminal device: provides the coordination policy to the network device.

### FIELD

Embodiments of the present disclosure generally relate to the field of telecommunication and in particular, to a method, device, apparatus and computer readable storage medium for redundant user plane paths coordination based on multiple terminal devices per terminal device group.

### BACKGROUND

5G and time-sensitive networking (TSN) technologies are key to future industrial communications: 5G for wireless connectivity and TSN for wired connectivity. According to 3GPP Rel-16, the 5GS functional architecture is integrated into an IEEE TSN network as a TSN bridge to support periodic deterministic time-sensitive Ethernet traffic flows. Ultra-reliability is critical for industrial communication especially for automatically control message transmission. In TSN, ultra-reliability is provided by frame replication and elimination for reliability (FRER) (802.1CB) for data flows through a per-packet-level reliability mechanism. This provides reliability by transmitting multiple copies of the same data packets over disjoint paths in the network. For a 5G+TSN scenario, FRER can be used in combination with 3GPP/5G redundancy features and provide end to end Ultra-reliability via application of FRER over both the TSN and 5G domains.

In Rel-15, 3GPP has already studied solutions for redundant user plane paths based on multiple terminal devices per terminal device group. A static reliability group (RG) approach (in which RG setup, management, terminal device scheduling is semi-static) is introduced to ensure that terminal device in the same terminal device group can be assigned different network device for redundancy. But the static RG approach does not work well in some scenarios to achieve efficient redundancy and guarantee ultra-reliability of TSN transmission.

### SUMMARY

In general, example embodiments of the present disclosure provide solutions for redundant user plane paths coordination.

In a first aspect, there is provided a network controller. The network controller comprises at least one processor and at least one memory storing instructions that, when executed by the at least one processor, cause the network controller at least to perform: receiving from a network device of a plurality of network devices managed by the network controller, status information comprising measurements provided by a terminal device to the network device and measurements specific to the network device; determining a coordination policy based on the status information, the coordination policy indicating a plurality of redundant user paths to be set by the network device for the terminal device; and providing the coordination policy to the network device.

In a second aspect, there is provided a network device. The network device comprises at least one processor; and at least one memory storing instructions, that, when executed by the at least one processor, cause the network device at least to perform: providing status information to a network controller, the network controller managing a plurality of network devices, wherein the status information comprises measurements provided by a terminal device to the network device, and measurements specific to the network device; receiving, a coordination policy from the network controller, wherein the coordination policy indicating a plurality of redundant user paths to be set by the network device for the terminal device; and processing, based on the coordination policy, a procedure of redundancy user plane configuration for the terminal device, wherein the terminal device belongs to the network device.

In a third aspect, there is provided a terminal device. The terminal device comprises at least one processor; and at least one memory storing instructions, that, when executed by the at least one processor, cause the apparatus at least to perform: providing status information from a terminal device to a network device, wherein the status information comprises measurement of the terminal device, and transmitting, a request of protocol data unit, PDU, session to the network device, wherein the terminal device belongs to the network device.

In a fourth aspect, there is provided a method implemented at a network controller. The method comprises receiving, at a network controller of a network system, the network controller managing a plurality of network devices, status information from a network device, wherein the status information comprises measurements provided by a terminal device to the network device, and measurements specific to the network device; determining by the network controller a coordination policy based on the status information, the coordination policy indicating a plurality of redundant user paths to be set by the network device for the terminal device; and providing the coordination policy to the network device.

In a fifth aspect, there is provided a method implemented at a network device. The method comprises providing status information from a network device to a network controller, the network controller managing a plurality of network devices, wherein the status information comprises measurements provided by a terminal device to the network device, and measurements specific to the network device; receiving, at the network device, a coordination policy from the network controller, wherein the coordination policy indicating a plurality of redundant user paths to be set by the network device for the terminal device; and processing, based on the coordination policy, a procedure of redundancy user plane configuration for the terminal device, wherein the terminal device belongs to the network device.

In a sixth aspect, there is provided a method implemented at a terminal device. The method comprises providing status information from a terminal device to a network device, wherein the status information comprises measurement of the terminal device, and transmitting, a request of protocol data unit, PDU, session to the network device, wherein the terminal device belongs to the network device.

In a seventh aspect, there is provided a non-transitory computer readable medium comprising program instructions for causing an apparatus to perform at least the method according to any one of the above fourth to sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a flowchart illustrating a process for redundant user plane paths coordination according to some embodiments of the present disclosure;

FIG. 3 illustrates a flowchart of a method implemented at a network controller (e.g., a Radio Intelligent Controller, RIC) according to some embodiments of the present disclosure;

FIG. 4 illustrates a flowchart of a method implemented at a network device according to some embodiments of the present disclosure;

FIG. 5 illustrates a flowchart of a method implemented at a terminal device according to some other embodiments of the present disclosure;

FIG. 6 illustrates a flowchart of a method implemented at a network controller (e.g., a Radio Intelligent Controller, RIC) about outputting coordination policy for a reliability group and diversity/redundancy degree;

FIG. 7 illustrates a simplified block diagram of an apparatus that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), NR (New Radio) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

The term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a network device), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The term “terminal device group” refers to any physical device that is equipped with one or more “terminal device”. The terminal device group which integrates multiple terminal devices can connect to different network devices independently. The selection of different network devices for the terminal devices in the same terminal device group is realized by the concept of UE Reliability Groups (RG) for the terminal devices and also for the cells of network device (refers to 3GPP TS 3GPP TS 23.501 V16.12.0). By grouping the terminal devices in the terminal device group and cells of network device in the network into more than one reliability group, the terminal devices in the same terminal device group can be assigned different network device for redundancy.

As used herein, a network controller may be a RAN Intelligent Controller (RIC). RIC is a new virtualized function which adds RAN programmability to existing or new RAN networks. Near RealTime RIC connects with network device/vCU+vDU via E2 interface, which support near real time (10-100 ms) data exchange between RIC and network device, thus 10-100 ms level RAN data collection and RRC control policy input can be realized by Near Real time RIC. Near Real time RIC will provide enhance function for CU-CP via xAPP, E2 interface and AI/ML capability. Similar like centralized CU, or RNC in WCDMA, the near Real-Time RIC will connect 100-1000 network device/DU, thus potentially play a role to centralized coordination the radio resource of the network device.

In Rel-15, 3GPP has already studied solutions for redundant user plane paths based on multiple terminal devices in the same terminal device group. A static Reliability group (RG) approach (in which RG setup, management, terminal device scheduling is semi-static) is introduced to ensure that terminal devices in the same terminal device group can be assigned different network device for redundancy. But the static RG approach does not work well in some scenarios to achieve efficient redundancy and guarantee ultra-reliability of TSN transmission.

According to embodiments of the present disclosure, there is provided a solution for redundant user plane paths coordination based on multiple terminal devices per terminal device group. In the solution, the dynamic features of RAN are considered, which, include, e.g., dynamic cell load, changing number of terminal device for each RG, terminal device mobility with different coverage, varying radio channel condition. Hence, the provided solution can coordinate RG setup, management, and selection via centralized coordination dynamically equipped with AI (artificial intelligence) inference capability.

In this solution, a new method is introduced to use centralized coordination and optional AI inference capability to realize dynamical U-plane redundancy optimization and make recommendations for Reliability Group (RGs) setup, management, and selection. The optimization will provide the highest diversity/redundancy degree for all selected redundant paths by leveraging real-time status information of terminal device and network device. The optimization will provide the highest diversity/redundancy degree to other entities, such as Non-RT RIC, OAM and/or 5GC for Service Level Agreement (SLA) management.

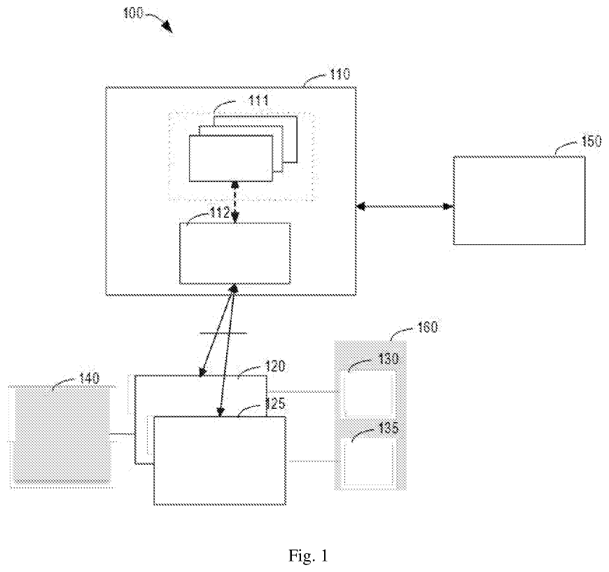

Principles and embodiments of the present disclosure will be described in detail below with reference to the accompanying drawings. Reference is first made to FIG. 1, which illustrates an example communication system 100 in which embodiments of the present disclosure may be implemented.

The system 100 includes the network controller, in particular the RIC 110. The system 100 includes a plurality of network devices, such as a network device 120 and a network device 125. The system 100 includes core network 140. The system 100 also includes one or more terminal devices, such as terminal devices 130, 135. The terminal device 130, 135 are in the same terminal device group 160. The system 100 also includes other node 150, such as Non-RT RIC. OAM and/or 5G core network (5GC), etc.

The RIC 110 is the centralized coordination function. It will subscribe and collect near-real-time status information about network devices and terminal devices. In one example embodiment, those inputs will be maintained in the prioritization table in the RIC. The status information and static information are the inputs for the centralized coordination and optional AI inference. In some embodiments, the RIC 110 has one or more AI/ML (machine learning) modules 111 and one coordination function module 112. The AI/ML (machine learning) modules 111 can perform AI inference function, such as, prediction of the Cell/RG load, terminal device mobility trajectory and/or channel quality of terminal device. And coordination function module 112 can perform centralized coordination function among different terminal devices and/or different network devices.

The RIC 110 will subscribe and collect new events from network devices, which would trigger the centralized coordination function and optional AI inference function to output the selection policy for a reliability group and the diversity/redundancy degree. The RIC 110 can provide diversity/redundancy degree to Non-RT RIC, OAM and/or 5GC. The diversity/redundancy degree is for the paths of terminal devices belong to same terminal device group.

The optimization principle for the centralized coordination function in RIC 110 can detect and allow the first PDU session establishment/modification request for the same terminal device group. The optimization principle can detect and select the RG for the second or greater ordinal number of the path with the highest diversity/redundancy degree compared to previously selected/setup RG(s) for established path(s), by using the information maintained in the prioritization table.

The RIC 110 may guild the serving network device to reject the terminal device's PDU session establishment/modification procedure and instruct the terminal device to re-initiate the procedure via a recommended network device.

The RIC 110 can provide each network device (which provided a PDU session establishment event) a recommended connection in the setup policy according to part of or all collected information.

The network device can have information of more than one terminal device, which indicates that the one or more terminal devices belonging to same terminal device group, then report to RIC 110 by the network device as one of the inputs for the centralized coordination and optional AI inference. The network device can report subscribed real-time status information of terminal devices, network device to the RIC. And the network device can report subscribed events to the RIC and wait for instruction from the RIC for further processing.

It is to be understood that the number of network devices and terminal devices is only for the purpose of illustration without suggesting any limitations. The system 100 may include any suitable number of RIC, network devices and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

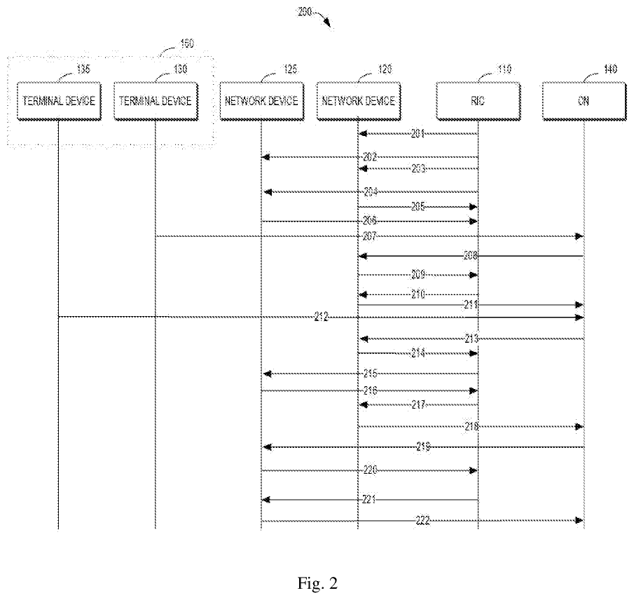

Reference is now made to FIG. 2, which shows a process 200 for redundant user plane paths coordination according to example embodiments of the present disclosure. For the purpose of discussion, the process 200 will be described with reference to FIG. 1. The process 200 may involve the terminal device 130, 135 and the network device 120, 125 as illustrated in FIG. 1. It would be appreciated that although the process 200 for link has been described in the communication system 100 of FIG. 1, this process may be likewise applied to other communication scenarios. It would also be appreciated that although the process for redundant user plane paths coordination of the terminal device 130 and 135 is discussed, a similar process can be applied for any other terminal devices for redundant user plane paths coordination.

In the process 200, at step 201, the RIC 110 subscribes to status information provided by network device 120. At step 202, the RIC 110 subscribes to status information reports provided by network device 125.

In some embodiments, the status information is at least one of near-real-time status information of the terminal device, near-real-time status information of the network device, and near-real-time status information of configuration of the reliability group.

In some embodiments, the status information of terminal device comprises: measurement of the terminal device and/or connection information of the terminal device, such as, current RG, current network device and UE radio channel measurements, DL RSRP (Reference Signal Receiving Power), RSRQ (Reference Signal Received Quality), RSSI (Received Signal Strength Indication), device location, etc.

In some embodiments, the status information of network device includes information of cell load, interferences, etc.

In some embodiments, the RIC 110 can read static information via O&M or A1 interface. The static information comprises: configurations of reliability group such as, the RGs and their bindings in network devices and UPFs (User Plane Functions), the connection weight among network devices and UPFs for different RGs. The static information may also comprise geographical and physical parameters of network devices and UPFs, such as, network device location, antenna location, antenna height, antenna angle, carrier, transport setting, UPF location, etc.

At step 203, RIC 110 subscribes to PDU session establishment/modification related messages provided by network device 120. In some embodiments. At step 204, RIC 110 subscribes to PDU session establishment/modification related messages provided by network device 125. When the network device 120 or 125 receives the PDU session establishment/modification related messages relevant to terminal device 130, the related event will be sent to RIC 110. And the event can trigger centralized runtime RG management of terminal device 130 and 135.

And the RIC 110, at step 205 and 206, can continuously receive status information from the network device 120 and 125. In some embodiments, the status information and static information will be maintained in the prioritization table in the RIC.

In the process 200, the terminal device 130 initiates the PDU session establishment/modification procedure and, at step 207, the request is sent to CN 140.

At step 208, the PDU session establishment/modification is sent to network device 120. In some embodiments, the network device 120 will firstly suspend all PDU Session establishment/modification steps, and extract the RG number, then at step 209, send detail information of the event to RIC 110.

After RIC 110 receives the event, at step 210, RIC 110 can provide coordination policy to network device 120. The coordination policy comprising redundant user path(s) of terminal device 130.

In some embodiments, RIC 110 checks status information of the terminal device 130. In the scenario of the path of terminal device 130 is the first path of the terminal device group, the RIC 110 sends the indication to network device 120 to start the PDU session establishment procedure by setup policy. And after network device 120 receives the indication from RIC 110, the network device 120 setup the path for the terminal device 130 and response to CN 140 at step 211.

In the process 200, the terminal device 135 and terminal device 130 are in the same terminal device group 160. After the terminal device 130 setup the PDU session by above steps, the terminal device 135 initiates the PDU session establishment/modification procedure and, at step 212, the request is sent to CN 140.

At step 213, the PDU session establishment/modification is sent to network device 120. In some embodiments, the network device 210 will firstly suspend all PDU Session establishment/modification steps, and extract the RG number, then at step 214, send detail information of the event to RIC 110.

After checking the information of the event, the RIC 110 finds this is not the first path of the terminal device group 160, so the centralized coordination operation in the RIC 110 will be triggered. In some embodiments, the coordination function module 112 in the RIC 110 takes status information and static information as inputs, then selects the highest diversity/redundancy degree compared to the previous paths, and then gives a recommended path as output.

In the scenario of the RG in the network device 125 is the best RG for terminal device 135, the RIC will provide the handover policy. In some embodiments, the RIC 110 sends the resource reservation policy as request for the resource reservation procedure to network device 125 at step 215. Network device 125 reserves resource for terminal device 135 and sends the response to RIC 110 at step 216.

At step 217, the RIC 110 sends handover policy to network device 120 for handover procedure. The network device 120 responses to CN 140 at step 218 about the handover. And the network device 120 triggers handover procedure for terminal device 135 according to 3GPP standards.

At step 219, the PDU session establishment/modification is sent to network device 125. In some embodiments, the network device 125 will firstly suspend all PDU Session establishment/modification steps, and extract the RG number, then at step 220, send detail information of the event to RIC 110.

After RIC 110 receives the event, at step 220, RIC 110 can check the status information and find that RG in network device 125 is the best RG. The RIC 110 sends the indication to network device 125 to start the PDU session establishment procedure at step 221. And after network device 125 receives the indication from RIC 110, the network device 125 setup the path for the terminal device 135 and response to CN 140 at step 222.

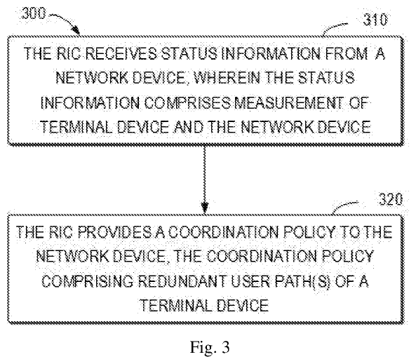

FIG. 3 shows a flowchart of an example method 300 implemented at a network controller, such as for instance a Radio Intelligent Controller, RIC, in accordance with some embodiments of the present disclosure. For the purpose of discussion, the method 300 will be described from the perspective of the RIC 110 with reference to FIG. 1.

At block 310, the RIC receives status information from at least one of a network device, wherein the status information comprises measurement of the terminal device and the network device. At block 320, the RIC a coordination policy based on the status information, the coordination policy comprising redundant user path(s) of a terminal device. The static information comprises configurations of reliability group such as, the RGs and their bindings in network devices and UPFs, the connection weight among network devices and UPFs for different RGs. The static information may also comprise geographical and physical parameters of network devices and UPFs such as, network device location, antenna location, antenna height, antenna angle, carrier, transport setting, UPF location, etc. At block 330, the RIC provide the coordination policy to the network device.

In some embodiments, the RIC provides diversity/redundancy degree to Non-RT RIC, OAM and/or 5GC, the diversity/redundancy degree being calculated based on at least one of the status information and the static information.

In some embodiments, the RIC has subscribed to the status information from the network device.

In some embodiments, the RIC has subscribed to events from the network device, the events being configured to trigger the RIC to provide the coordination policy.

In some embodiments, the RIC provides the coordination policy based on artificial intelligence inference.

In some embodiments, the RIC maintains the status information and static information.

In some embodiments, the status information the status information of the terminal device comprises: measurement of the terminal device and/or connection information of the terminal device.

In some embodiments, the static information of the network comprises: configurations of the reliability group, geographical parameters, and physical parameters.

In some embodiments, the coordination policy comprises a setup policy, a selection policy, a resource reservation policy and/or a handover policy for a reliability group.

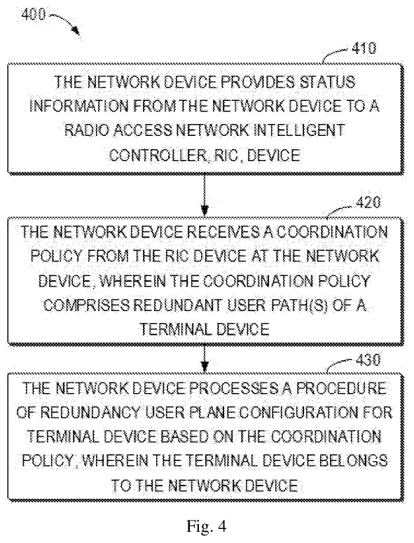

FIG. 4 shows a flowchart of an example method 400 implemented at a network device in accordance with some embodiments of the present disclosure. For the purpose of discussion, the method 400 will be described from the perspective of the network device 120 with reference to FIG. 1.

At block 410, the network device 120 provides status information from the network device to the network controller or RIC. At block 420, the network device 120 receives a coordination policy from the network controller. At block 430, the network device 130 processes/performs a procedure of redundancy user plane configuration for terminal device based on the coordination policy.

In some embodiments, the network controller or RIC has subscribed to the status information from the network device.

In some embodiments, the network controller or RIC has subscribed to events from the network device, the events being configured to trigger the network controller to provide the coordination policy.

In some embodiments, the status information is near-real-time status information of the network devices.

In some embodiments, the static information of the network comprises: configurations of reliability group, geographical parameters, and physical parameters.

In some embodiments, the procedure of PDU session comprises at least one of an establishment procedure, a resource reservation procedure and a handover procedure.

In some embodiments, the network device has information of more than one terminal devices, which belonging to same terminal device group, the information of more than one terminal devices being reported to the network controller by the network device.

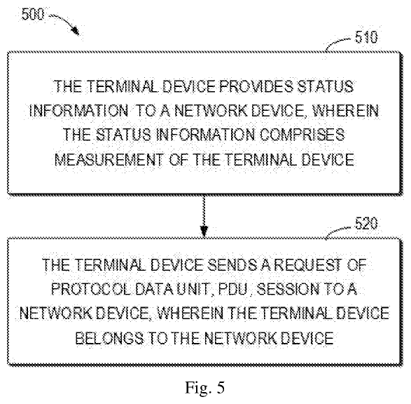

FIG. 5 shows a flowchart of an example method 500 implemented at a terminal device in accordance with some embodiments of the present disclosure. For the purpose of discussion, the method 500 will be described from the perspective of the terminal device 130 with reference to FIG. 1.

At block 510, the terminal device 130 provides status information from the terminal device to a network device, wherein the status information comprises measurement of the terminal device.

At block 520, the terminal device 130 sends a request of protocol data unit, PDU, session to a network device, wherein the terminal device belongs to the network device.

In some embodiments, the status information is near-real-time status information of the terminal device.

In some embodiments, the status information of the terminal device comprises: measurement of the terminal device and/or connection information of the terminal device.

In some embodiments, the terminal device has information of more than one terminal devices, which belonging to same terminal device group, the information being reported to or subscribed by the network device.

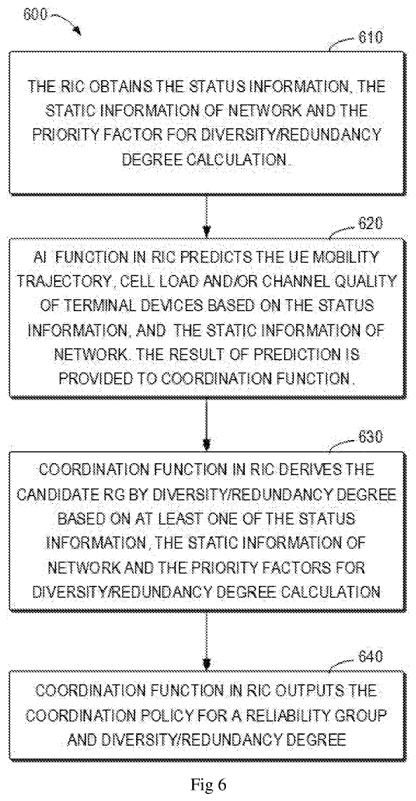

Reference is now made to FIG. 6, which shows a flowchart of a method implemented at a RIC about outputting coordination policy for a reliability group and diversity/redundancy degree by AI algorithm.

The selection policy for a reliability group and diversity/redundancy degree are provided by RIC 110 based on at least one of the status information between network devices in different reliability group, the status information of terminal devices in the same terminal device group, the static information of network and the priority factors for diversity/redundancy degree calculation. In some embodiments, the priority factors for diversity/redundancy degree calculation are inputs from OAM, non-real time RIC or CN.

At step 610, the RIC 110 obtains the status information between network devices in different reliability groups, the status information of terminal devices in the same terminal device group, the static information of network and the priority factors for diversity/redundancy degree calculation.

At step 620, the AI function in RIC 110 predicts the UE mobility trajectory, cell load and/or channel quality of terminal devices based on the status information of terminal devices in the same terminal device group, the status information of the network device and/or the static information of network. The result of prediction is provided to coordination function.

At step 630, the coordination function in RIC 110 derives the candidate RG by the diversity/redundancy degree based on at least one of the status information of terminal devices in the same terminal device group, the static information of network and the priority factors for diversity/redundancy degree calculation.

At step 640, coordination function in RIC 110 outputs the coordination policy for a reliability group and diversity/redundancy degree according to the candidate RG and the prediction result from the AI function.

In some embodiments, the status information may include near-real time measurement of the terminal device, the connection information of the terminal device, the near-real time measurement of the network device, etc.

In some embodiments, the near-real time measurement of the network device may include cell load, interference etc.

In some embodiments, the connection information of the terminal device may include the candidate network device information of different terminal device.

In some embodiments, the near-real time measurement of the terminal device may include network device beam parameters, channel measurement, etc.

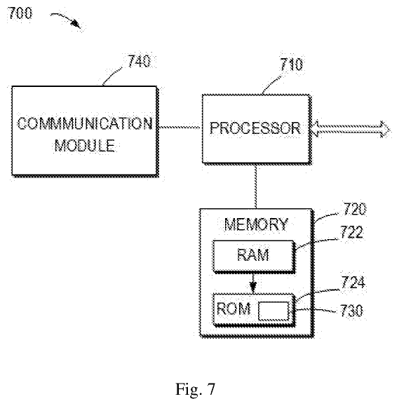

FIG. 7 is a simplified block diagram of a device 700 that is suitable for implementing embodiments of the present disclosure. The device 700 may be provided to implement the communication device, for example the terminal device 130 or the terminal device 135, the network device 120 or the network device 125, the RIC 110 as shown in FIG. 1. As shown, the device 700 includes one or more processors 710, one or more memories 720 coupled to the processor 710.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 1020. The processor 710 may perform any suitable actions and processing by loading the program 730 into the RAM 1020.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

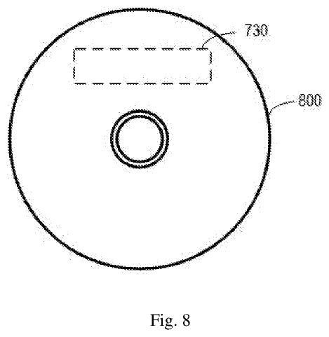

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 as described above with reference to FIGS. 2 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server. In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A network controller, comprising:
at least one processor; and
at least one memory storing instructions that, when executed by the at least one processor, cause the network controller at least to perform:
receiving from a network device of a plurality of network devices managed by the network controller status information comprising measurements provided by a terminal device to the network device and measurements specific to the network device;
determining a coordination policy based on the status information, the coordination policy indicating a plurality of redundant user paths to be set by the network device for the terminal device; and
providing the coordination policy to the network device.

2. The network controller according to claim 1, further configured to obtain static information describing a configuration of the plurality of network devices, and to determine the coordination policy based on the status information and the static information.

3. The network controller according to claim 1, further configured to provide diversity/redundancy degree to a non-real-time network intelligent controller, an operation administration and maintenance, OAM and/or a 5G core network, the diversity/redundancy degree being calculated based on the status information and/or the static information.

4. The network controller according to claim 1, further configured to receive events from the network device, the events being configured to trigger the network controller to provide the coordination policy.

5. The network controller according to claim 1, further configured to determine the coordination policy by using a machine learning model.

6. The network controller according to claim 1, wherein the status information comprises at least one of near-real-time status information of the terminal device, near-real-time status information of the network device, and near-real-time status information of configuration of reliability groups, wherein the reliability group comprises configurations of the different redundant user paths for the terminal devices in the same terminal device group.

7. The network controller according to claim 1, wherein the status information of the terminal device comprises information indicating a connection status of the terminal device with at least one network device of the plurality of network devices.

8. The network controller according to claim 1, wherein the static information comprises: configurations of reliability groups, geographical parameters, and physical parameters, wherein the reliability group comprises configurations of the different redundant user paths for the terminal devices in the same terminal device group.

9. The network controller according to claim 1, wherein the static information is provided by at least one of network system components selected from operation administration and maintenance, OAM, network management system, NMS and service management and orchestration, SMO.

10. The network controller according to claim 1, wherein the coordination policy comprises at least one of a setup policy, a resource reservation policy and a handover policy.

11. The network controller according to claim 1, wherein the network controller is any one of network intelligent controller, RIC, non-real time network intelligent controller, Non-RT RIC or near-real time network intelligent controller, Near-RT RIC.

12. A network device, comprising:
at least one processor; and
at least one memory storing instructions, that, when executed by the at least one processor, cause the network device at least to perform:
providing status information to a network controller, the network controller managing a plurality of network devices, wherein the status information comprises measurements provided by a terminal device to the network device, and measurements specific to the network device;
receiving, a coordination policy from the network controller, wherein the coordination policy indicating a plurality of redundant user paths to be set by the network device for the terminal device; and
processing, based on the coordination policy, a procedure of redundancy user plane configuration for the terminal device.

13. The network device according to claim 12, further configured to provide events to the network controller to trigger the network controller to provide the coordination policy.

14. The network device according to claim 12, wherein the status information comprises near-real-time status information of the network device.

15. The network device according to claim 12, wherein the status information of the network comprises information of cell load and interferences.

16. The network device according to claim 12, wherein the procedure of redundancy user plane configuration comprises at least one of an establishment procedure, a resource reservation procedure and a handover procedure.

17. The network device according to claim 12, wherein the network device has information of more than one terminal devices, which belonging to same terminal device group, the information of more than one terminal devices being reported to the network controller by the network device.

18.-21. (canceled)

22. A method comprising:
receiving at a network controller of a network system, the network controller managing a plurality of network devices, status information from a network device, wherein the status information comprises measurements provided by a terminal device to the network device, and measurements specific to the network device;
determining by the network controller a coordination policy based on the status information, the coordination policy indicating a plurality of redundant user paths to be set by the network device for the terminal device; and
providing by the network controller the coordination policy to the network device.

23. A method comprising:
providing by a network device status information to a network controller, the network controller managing a plurality of network devices, wherein the status information comprises measurements provided by a terminal device to the network device and measurements specific to the network device;
receiving at the network device a coordination policy from the network controller, wherein the coordination policy indicating a plurality of redundant user paths to be set by the network device for the terminal device; and
processing, based on the coordination policy, a procedure of redundancy user plane configuration for the terminal device.

24. (canceled)

25. (canceled)
